(19) United States
(12) Patent Application Publication
(10) Pub. No.: US 2026/0268105 A1
(43) Pub. Date: Sep. 10, 2026

(54) DELIVERY SERVER FOR TRANSMITTING, TO DEVICE, SPECIFIC DATA USED FOR DISPLAYING IMAGE OF INPUT CHARACTER STRING RENDERED IN SELECTED FONT

(71) Applicant: BROTHER KOGYO KABUSHIKI KAISHA, Nagoya (JP)

(72) Inventors: Jun YAMADA, Nagoya (JP); Ryoji BAN, Kiyosu (JP); Fuyuko ITO, Yokkaichi (JP)

(21) Appl. No.: 19/555,556

(22) Filed: Mar. 3, 2026

(30) Foreign Application Priority Data
Mar. 7, 2025 (JP) 2025-036754

(51) Int. Cl. G06K 15/02; G06F 3/12; G06F 40/109

(52) U.S. Cl. CPC G06K 15/1802; G06F 3/1206; G06F 3/1256; G06F 3/1288; G06F 40/109; G06K 15/024

(57) ABSTRACT

A delivery server includes a controller. In response to receiving a font list request transmitted from a first device, the controller transmits a first server font list to the first device. The first server font list is a list of server fonts. The server fonts are fonts available to the delivery server. In response to receiving a specific data request transmitted from the first device, the controller obtains specific data used for displaying a first character string image and transmits the obtained specific data to the first device. The specific data request specifies a character string inputted on the first device, and identification information identifying a server font selected from the first server font list on the first device. The first character string image is an image of the specified character string rendered in the server font identified by the identification information specified in the received specific data request.

### REFERENCE TO RELATED APPLICATIONS

This application claims priority from Japanese Patent Application No. 2025-036754 filed on Mar. 7, 2025. The entire content of the priority application is incorporated herein by reference.

### BACKGROUND ART

A known delivery server stores and delivers label data. For example, in a known system, a server side includes a personal computer used to design labels, a label database that stores label data of the labels, and a registration number database for assigning product numbers, while a client side includes a personal computer, a printer, and a cutting plotter which are used to issue labels. The server and client are connected to each other and configured to perform integrated processes for designing, issuing, and cutting labels.

### SUMMARY

In some cases, label data created on a client device is stored on a delivery server and subsequently displayed from the delivery server. However, if the delivery server does not possess fonts specified for text included in the label data, the text cannot be displayed in the fonts intended by the person who uploaded the label data, i.e., the label data creator.

In order to attain the above and other objects, the present disclosure provides a delivery server configured to be connected to a network. The delivery server includes a controller. In response to receiving a font list request transmitted from a first device configured to be connected to the network, the controller is configured to perform transmitting a first server font list to the first device. The first server font list is a list of server fonts. The server fonts are fonts available to the delivery server. In response to receiving specific data request transmitted from the first device that is in receipt of the first server font list, the controller is configured to perform: obtaining specific data used for displaying a first character string image; and transmitting the obtained specific data to the first device. The specific data request specifies a character string inputted on the first device. The specific data request further specifies identification information identifying a server font selected from the first server font list on the first device. The first character string image is an image of the specified character string rendered in the server font identified by the identification information specified in the received specific data request.

In the above configuration, the delivery server transmits, to the first device, the first server font list including the server fonts, which are fonts available to the delivery server. When a creator of label data selects a server font from the first server font list and inputs a character string on the first device, the delivery server receives a specific data request and transmits, to the first device, specific data used for displaying an image of the input character string rendered in the selected server font. Therefore, the character string can be displayed on the first device in the fonts intended by the creator of the label data.

The functions of the above-described delivery server may be implemented by an apparatus, a control method, and a non-transitory computer-readable storage medium storing a computer program.

According to another aspect, the present disclosure provides a non-transitory computer-readable storage medium storing a set of computer-readable instructions for editing label data for a label. The set of computer-readable instructions, when executed by a processor of an information processing device configured to be connected to a network, causes the information processing device to perform: obtaining a server font list from a delivery server configured to be connected to the network, the server font list being a list of server fonts, the server fonts being fonts available to the delivery server; receiving a selection operation to select a server font from the obtained sever font list; receiving an input operation to input a character string to be placed in a label; transmitting a specific data request to the delivery server, the specific data request specifying identification information identifying the server font selected through the received selection operation, the specific data request further specifying the character string inputted through the received input operation; receiving specific data that is transmitted from the delivery server in response to the specific data request, the specific data being data used for displaying a character string image, the character string image being an image of the inputted character string rendered in the selected server font; and displaying, on a user interface of the information processing device, the character string image using the received specific data.

The functions of the above-described storage medium may be implemented by an apparatus and a control method.

### BRIEF DESCRIPTION OF DRAWINGS

FIG. 1 illustrates a schematic configuration of a delivery system.

FIG. 2 is a sequence diagram illustrating an example procedure for generating label data.

FIG. 3 illustrates an example of a label editing screen.

FIG. 4 is a sequence diagram illustrating an example procedure for displaying the label data.

FIG. 5 is a flowchart illustrating an example procedure of a preview rendering process.

FIG. 6 illustrates an example of a label display screen.

FIG. 7 illustrates an example of a web editing screen.

FIG. 8 is another sequence diagram illustrating an example procedure for generating label data.

### DESCRIPTION

Next, a delivery server that delivers label data according to an embodiment of the present disclosure will be described while referring to the accompanying drawings. This embodiment discloses a delivery system in which a delivery server, a delivery source device, and a delivery destination device are connected to each other via a network. In this system, the delivery server delivers, to the delivery destination device, label data uploaded to the delivery server from the delivery source device.

### First Embodiment

### Overall Configuration of the Delivery System

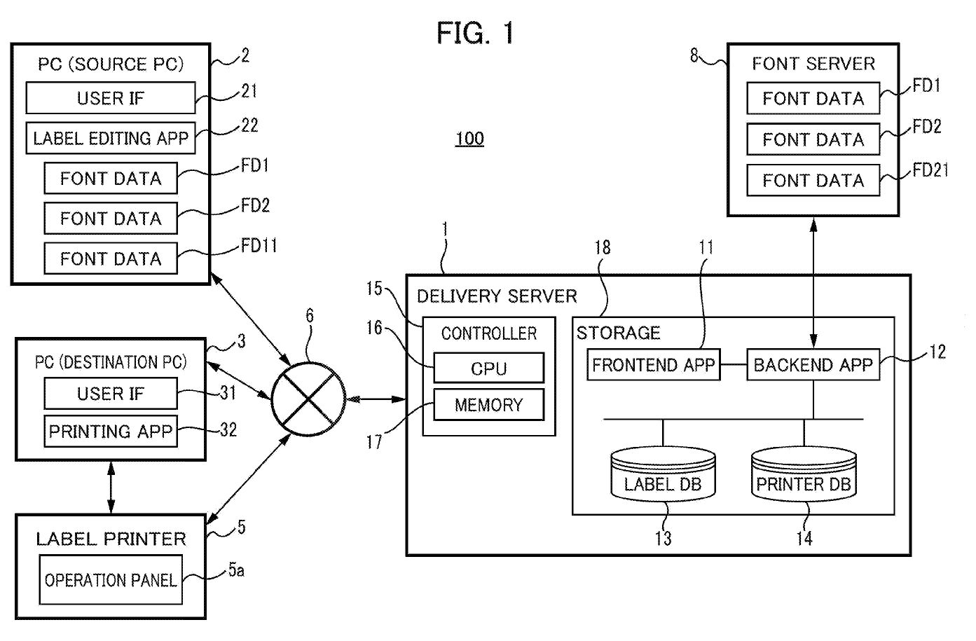

FIG. 1 shows a delivery system (hereinafter simply referred to as a “system”) 100 according to a first embodiment of the present disclosure. The system 100 includes a delivery server 1, a font server 8, a personal computer (hereinafter, “PC”) 2, a PC 3, a label printer 5, and a network 6. The delivery server 1 is configured to be connected to the network 6, such as the Internet. The delivery server 1 is configured to be communicatively connected to the font server 8. The font server 8 stores font data for each font, which is available to the delivery server 1. The delivery server 1 may be connected directly to the font server 8 or may be connected to the font server 8 via the network 6 or the like. The font server 8 in this embodiment stores font data FD1, font data FD2, and font data FD21. A font represented by the font data FD1, a font represented by the font data FD2, and a font represented by the font data FD21 are each an example of a server font.

The PC 2, the PC 3, and the label printer 5 are configured to be connected to the network 6. The PC 2, the PC 3, and the label printer 5 are configured to be communicatively connected to the delivery server 1 via the network 6. The delivery server 1 is managed by the vendor of the label printer 5 or the like. In the present embodiment, the delivery server 1 has a function for storing label data representing labels, and a function for delivering the stored label data.

As an example, the PC 3 and label printer 5 are provided in a store, such as a supermarket. The label printer 5 has at least a communication function and a printing function. The label printer 5 includes an operation panel 5a. The operation panel 5a is provided on the main body of the label printer 5. The operation panel 5a includes operating parts that receive various operations specifying print settings, device-side print instructions to execute prints, and the like. The operation panel 5a further includes a display for displaying data.

The label printer 5 is configured to accommodate a continuous sheet in roll form and has functions for printing images on the sheet to create labels. The rolled sheet is a printing medium in which a sheet and a continuous strip of release paper are overlaid on each other and wound together into a roll. The sheet may be a continuous elongate tape or may die-cut labels that have been pre-cut into a predetermined shape. A cassette that accommodates the rolled sheet is removably mountable to the label printer 5.

A plurality of types of cassettes are mountable to the label printer 5. The various types of cassettes include cassettes that accommodate continuous elongate tape, cassettes that accommodate die-cut labels for price tags, and cassettes that accommodate die-cut labels for addresses. The sheets accommodated in these cassettes vary in text color, background color, sheet size, material, and the like depending on the cassette model. Sheet size includes the sheet width, which is the dimension of the sheet in a direction orthogonal to the sheet conveying direction, and the sheet length, which is the dimension of the sheet in the conveying direction. The material of the sheet may be paper, a resin sheet, or cloth, for example. The label printer 5 of the present embodiment may also have functions for cutting and discharging the printed portion of the sheet after printing.

The PC 3 is configured to be communicatively connected to the label printer 5. Communication may be achieved through a wired or wireless method. The PC 3 includes a user interface (denoted as “user IF” in the drawings) 31 that displays information. The user interface 31 may include an operating function for receiving inputted information. A printing application program (hereinafter called a “printing app”) 32 that controls printing performed by the label printer 5 is installed on the PC 3.

The printing app 32 is a program provided by the vendor of the label printer 5 or the like. The printing app 32 is configured to use services provided by the delivery server 1. The printing app 32 enables the PC 3 to download label data from the delivery server 1. According to the printing app 32, the PC 3 is configured to display a settings screen that receives print settings based on the capabilities of the label printer 5. Thus, the PC 3 can receive print settings through the settings screen. The printing app 32 is configured to output, to the label printer 5, a print command that instructs the label printer 5 to print label data downloaded from the delivery server 1 using the print settings received via the settings screen. In the following description, the PC 3 will be sometimes referred to as the “destination PC 3.”

The label printer 5 may be connected to the delivery server 1 via the destination PC 3 or may be connected directly to the delivery server 1. Although FIG. 1 shows just one each of the destination PC 3 and the label printer 5, in reality, multiple destination PCs 3 and multiple label printers 5 installed in various stores are connected to the delivery server 1.

The PC 2 is provided in a management company that manages the above stores, for example. The PC 2 is a device having at least a communication function, a display function, and an operating function. The PC 2 includes a user interface (denoted as “user IF” in the drawings) 21 that displays information. The user interface 21 may have an operating function for receiving inputted information. A label editing application program (hereinafter called a “label editing app”) 22 having label editing functions is installed on the PC 2. The label editing app 22 is an example of a set of computer-readable instructions.

The label editing app 22 is configured to display a label editing screen on the user interface 21 and to receive operations via the screen for editing labels. The label editing screen is a screen in which objects can be arranged. The user of the PC 2 can place objects in the label editing screen. Examples of objects include text, images, shapes, frames, barcodes, and the like. The PC 2 possesses font data FD1, FD2, and FD11. The label editing app 22 can utilize the font data FD1, FD2, and FD11 when editing text and the like contained in label data. The font data possessed by the PC 2 may be font data registered in the operating system (hereinafter “OS”) of the PC 2, may be font data registered in the label editing app 22 rather than the OS, or may be font data registered in both of the OS and the label editing app 22.

The font data possessed by the source PC 2 need not exactly match the font data possessed by the font server 8. For example, the PC 2 may or may not possess font data that cannot be used on the delivery server 1, i.e., font data that is not possessed by the font server 8, such as the font data FD11. Conversely, the font server 8 may or may not possess font data that is not possessed by the PC 2, such as the font data FD21, which is available to the delivery server 1.

Font data includes information indicating a font (letter form) of characters designed in a respective predetermined style. For example, font data includes information indicating a font name, weight (character thickness), glyphs, character order, and character codes. The font name indicates the name of the font. Glyphs are the character data of the font and include information regarding the outline and body of each character.

The label editing app 22 is a program provided by the vendor of the label printer 5 or the like. The label editing app 22 is configured to use the services provided by the delivery server 1. The label editing app 22 enables the PC 2 to upload edited label data to the delivery server 1. The process of uploading label data will be described later. In the following description, the PC 2 will be sometimes referred to as the “source PC 2.”

The label editing app 22 is configured to be communicatively connected to the delivery server 1 via its own browser function or via a browser possessed by the source PC 2. The browser of the source PC 2 may be preinstalled in the operating system (hereinafter simply “OS”) of the source PC 2, or may be installed separately from the OS. The printing app 32 is configured to be communicatively connected to the delivery server 1 via its own browser function or via a browser possessed by the destination PC 3. The browser of the destination PC 3 may be preinstalled in the OS of the destination PC 3, or may be installed separately from the OS.

The source PC 2 is an example of a first device. The source PC 2 is also an example of an information processing device. The destination PC 3 and the label printer 5 are each an example of a second device. The label printer 5 is also an example of a printer. Each of the first device, the second device, and the information processing device may be a smartphone or a tablet device.

### Configuration of the Delivery Server 1

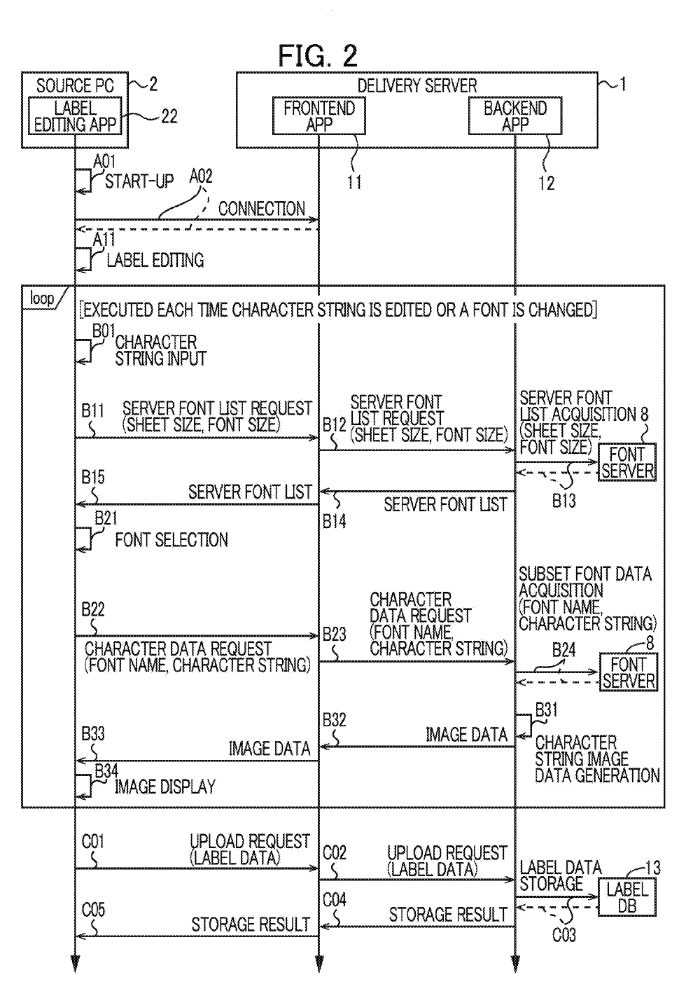

The delivery server 1 has at least a communication function and a storage function. The delivery server 1 includes a storage 18 and a controller 15. The storage 18 stores various programs, databases, and other information. For example, the storage 18 may include a read-only memory, a solid-state drive (SSD), a hard disk drive (HDD), or any combination thereof. The controller 15 includes a central processing unit (CPU) 16 and a memory 17. The CPU 16 is a processer that performs data processing. The CPU 16 of the controller 15 executes processes in accordance with programs stored in the storage 18. The memory 17 temporarily stores various intermediate data generated when the CPU 16 executes processes. For example, the memory 17 may include a random-access memory (RAM) or the like. The delivery server 1 has a frontend app 11 and a backend app 12. The frontend app 11 and backend app 12 are stored in the storage 18. The frontend app 11 and backend app 12 work together to execute processes on the delivery server 1. The processes on the delivery server 1 may be executed by a single application. The delivery server 1 shown in FIG. 1 is configured as a single device, but the delivery server 1 may be configured as a system including multiple devices. As with the delivery server 1, each of the PC 2, the PC 3, the label printer 5, and the font server 8 includes a storage and a controller including a processor (e.g., a CPU) and a memory. The label editing app 22 is stored in the storage of the PC 2, and the printing app 32 is stored in the storage of the PC 3. Among the processes shown in FIGS. 2, 4 and 8, those performed by the delivery server 1 are carried out by the controller 15 executing the frontend app 11 and backend app 12, those performed by the PC 2 are carried out by the controller of the PC 2 executing the label editing app 22, and those performed by the PC 3 are carried out by the controller of the PC 3 executing the printing app 32. The storage 18 of the delivery server 1, the storage of the PC 2, the storage of the PC 3, the storage of the label printer 5, and the storage of the font server 8 are each a non-transitory computer-readable storage medium.

The frontend app 11 is not installed on an information processing device connected to the delivery server 1 but is a web application that can be used via a browser on the information processing device. The frontend app 11 provides screens that can be displayed in the browser for receiving user operations, for example. The frontend app 11 includes various page information for displaying screens on the source PC 2 and destination PC 3.

The backend app 12 is a program that executes various processes in accordance with requests from the frontend app 11. Specifically, the backend app 12 is configured to be communicatively connect to the font server 8 to utilize font data stored on the font server 8. Specifically, the backend app 12 is configured to access various databases to store and retrieve information. The databases accessible by the backend app 12 in this example are a label database 13 (denoted as “label DB 13” in the drawings) and a printer database 14 (denoted as “label DB 14” in the drawings). The label database 13 and printer database 14 are provided in the delivery server 1 in the example of FIG. 1, but these databases may be provided in an external device. In this embodiment, the label database 13 and printer database 14 are stored in the storage 18. However, the label database 13 and printer database 14 may be stored in a storage in an external device.

Label data is stored in the label database 13. For example, a record is created in the label database 13 for each set of label data. Each record stores a label ID identifying a label, the label name of the label, a set of label data for the label, a sample image of the label, and an update history in association with one another. A plurality of sets of label data uploaded to the delivery server 1 are stored in the label database 13.

The printer database 14 stores printer information on printers connected to the network 6. A record is created in the printer database 14 for each printer. Each record stores a printer ID identifying a printer, the name of the printer, a model name specifying the model of the printer, capability information specifying capabilities of the printer, and destination information such as an IP address of the printer in association with one another. The delivery server 1 is configured to communicate with the printers registered in the printer database 14 and to deliver label data stored in the label database 13 to the printers, for example.

### Operation Description

The operation of the system 100 will be described next. The procedures and process steps of the programs described in the present disclosure basically indicate processes executed by a CPU of a device in accordance with instructions included in the programs. In other words, each process having an action description such as “judge,” “determine,” “obtain,” “receive,” or the like represents a process executed by the CPU of the device. Note that the term “obtain” is used under a concept that does not require a request. The processes executed by the CPU include hardware control using the API in the OS of the device. However, a description of the role of the OS is omitted in this specification when describing the operations of the programs. Furthermore, in the following specification, a process executed by a CPU of a device according to instructions in a program may be described using abbreviated expressions, such as “the CPU executes.” Similarly, a process executed by the CPU according to instructions in an application program may be described using expressions that omit the CPU, such as “the program executes,” “the app executes” or “the device executes.”

### Editing Labels

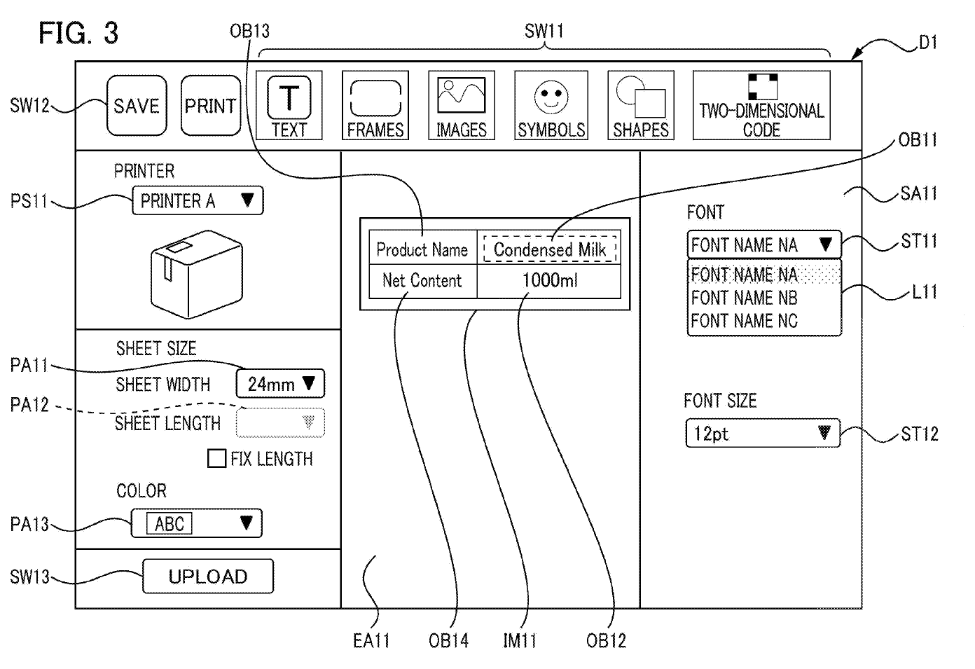

First, a procedure for editing labels on the source PC 2 will be described. In A01 of FIG. 2, the user of the source PC 2 starts up the label editing app 22. In A02 the source PC 2 connects to the delivery server 1 using a browser function of the label editing app 22 or a browser installed on the source PC 2. In A11 the label editing app 22 displays a label editing screen D1 shown in FIG. 3 on the user interface 21 and receives label editing instructions, for example. Note that the source PC 2 may connect to the delivery server 1 at a time when the label editing app 22 displays the label editing screen D1, or at a time after the user begins editing a label, such as when a text object is selected.

FIG. 3 shows an example of the label editing screen D1. In this example, the label editing screen D1 displays an image IM11 of label data in which a plurality of objects are arranged. The label editing screen D1 has a printer selection field PS11 for selecting a printer, and a sheet size setting area for setting the sheet size. The sheet size setting area includes a sheet width setting field PA11 for setting the sheet width, and a sheet length setting field PA12 for setting the sheet length, for example. When the length is fixed, the sheet length setting field PA12 is enabled. On the other hand, when the length is not fixed, the sheet length setting field PA12 is disabled, e.g., grayed out. The label editing screen D1 also has a color setting field PA13 for setting the text color of the sheet and the background color of the sheet.

The label editing app 22 includes a plurality of objects prepared in advance. Examples of objects include text, frames, images, shapes, and two-dimensional codes. The label editing screen D1 has an object selection button set SW11 for selecting objects. Objects selected through the object selection button set SW11 are placed in a label editing area EA11 of the label editing screen D1. Here, the label editing area EA11 displays the image IM11 of label data currently being edited. In this example, text objects OB11, OB12, OB13, and OB14 have been arranged in the label editing area EA11.

The label editing screen D1 also has an object attribute setting area SA11 for setting attributes of objects. The content displayed in the object attribute setting area SA11 changes according to the object selected in the label editing area EA11, enabling the user to set attributes for the selected object. The image IM11 reflects the object attributes set in the object attribute setting area SA11.

As an example, when the text object OB11 has been selected, the label editing app 22 displays in the object attribute setting area SA11 a font selection field ST11 for selecting a font, and a font size setting field ST12 for setting the font size. The font selection field ST11 enables the user to select one font from a font list L11. The font list L11 lists the fonts that can be specified for the text object OB11.

As shown in FIG. 2, the label editing app 22 executes the loop in B01-B34 each time a character string is edited or a font is changed. For example, when in B01 the user inputs a new character string, such as “Condensed Milk,” into the text object OB11 or modifies a previously inputted character string, in B11 the label editing app 22 accesses the frontend app 11 and transmits a server font list transmission request to the frontend app 11. The server font list transmission request is a request to transmit a server font list to the source PC 2 (specifically to the label editing app 22). The server font list transmission request in B11 specifies the sheet size including the values set in the sheet width setting field PA11 and the sheet length setting field PA12 of the label editing screen D1, and the font size set in the font size setting field ST12. The server font list transmission request is an example of a font list request. The user’s input operation to input the new character string in B01 is an example of an input operation.

In B12 the frontend app 11 forwards the server font list transmission request, in which the sheet size and font size are specified, to the backend app 12.

In response to receiving the server font list transmission request, in B13 the backend app 12 obtains a list of server fonts from the font server 8. In the present disclosure, the term “server fonts” refers to fonts available to the delivery server 1. Examples of fonts available to the delivery server 1 include fonts represented by font data stored in the delivery server 1 and fonts represented by font data obtainable from a font management server (e.g., the font server 8) accessible to the delivery server 1. In the present embodiment, the font server 8 possesses font data for each of the server fonts. In this embodiment, the backend app 12 transmits, to the font server 8, a request for transmission of a list of server fonts suitable for the sheet size and font size specified in the server font list transmission request. This request also specifies the sheet size and font size specified in the server font list transmission request. The font server 8 extracts server fonts suitable for the sheet size and font size specified in the request and transmit a server font list including the extracted server fonts to the backend app 12. The server font list includes identification information identifying the extracted server fonts but does not include the actual font data for the extracted server fonts. Examples of identification information are font names. The identification information may include, for each server font, glyphs representing each character in the font name.

As an alternative, the backend app 12 may generate a server font list itself by first obtaining all server fonts stored on the font server 8 in B13 and then extracting server fonts suitable for the sheet size and font size specified in the request of B12.

The server font list may include server fonts suitable for either the sheet size or font size. The server font list may include all server fonts possessed by the font server 8. However, by obtaining the server font list limited to server fonts suitable for the sheet size specified via the label editing screen D1, the delivery server 1 can exclude fonts that do not fit on the tape, for example, from the fonts that can be specified for character strings. Further, by obtaining the server font list limited to server fonts suitable for the font size specified via the label editing screen D1, the delivery server 1 can exclude, from the fonts that can be used in character strings, fonts that cause a portion of a character to be not displayed or to be clipped when the font size is too small.

In B14 the backend app 12 passes the server font list obtained from the font server 8 to the frontend app 11. In B15, the frontend app 11 transmits the server font list received from the backend app 12 to the label editing app 22, which is the source of the server font list transmission request in B11. The server font list transmitted in B15 is an example of a first server font list.

The label editing app 22 generates the font list L11 using the server fonts included in the server font list. In B21 the user of the label editing app 22 selects one server font from the font list L11, that is, from the server font list. Here, the font list L11 displays identification information such as the font names identifying the fonts. The font name itself may be rendered in the font list L11 using glyphs in the corresponding font. The font list L11 is an example of a server font list and is also an example of a first server list. The user’s operation to select one server font from the font list L11 in B21 is an example of a selection operation.

As shown in FIG. 2, the font list L11 includes only font names for server fonts stored on the font server 8, such as the font name “Font Name NA” for the font data FD1, the font name “Font Name NB” for the font data FD2, and the font name “Font Name NC” for the font data FD21, and does not include font names for fonts not possessed by the font server 8, such as the font name for the font data FD11. Accordingly, the label editing app 22 can avoid fonts not possessed by the font server 8 from being specified for the text object OB11. The label editing app 22 can also specify fonts not possessed by the source PC 2, such as the font data FD21, for the text object OB11, provided that the font is stored on the font server 8.

In B22 the label editing app 22 transmits a character data transmission request to the frontend app 11 in response to input of a character string or selection of a font. The character data transmission request is a request to transmit character data to the source PC 2 (specifically to the label editing app 22). The character data transmission request specifies information used for generating image data of the character string. Information used to generate image data of a character string includes at least identification information (i.e., the font name) identifying the server font selected in B21, and the character string (“Condensed Milk” in this example) inputted in the selected text object OB11. That is, the character data transmission request specifies the character string inputted in the selected text object OB11on the source PC 2 and identification information identifying the server font selected from the font list L11 on the source PC 2 in B21. Information used to generate image data of a character string may also include the text color and background color set in the color setting field PA13 of the label editing screen D1 and the font size set in the font size setting field ST12. The character data transmission request in B22 is an example of a specific data request.

In B23 the frontend app 11 forwards the character data transmission request received from the label editing app 22 in B22 to the backend app 12.

In response to receiving the character data transmission request, in B24 the backend app 12 extracts the font name of the server font and the character string included in the information used for generating the image data of the character string, and obtains, from the font server 8, subset font data that corresponds to both the extracted font name of the server font and the extracted character string. The subset font data obtained in B24 is an example of first subset font data.

For example, when the font name “Font Name NA” (i.e., the identification information identifying the server font that is represented by the font data FD1) is selected in B21, the information used for generating the image data of the character string specified in the request of B23 includes the character string “Condensed Milk,” and the font name “Font Name NA.” The backend app 12 then transmits, to the font server 8, a request for transmission of subset font data. This request specifies the character string “Condensed Milk” and the font name “Font Name NA.”

The font server 8 reads the font data FD1 based on the specified font name “Font Name NA,” extracts one or more glyphs for each character constituting the specified character string “Condensed Milk” from the font data FD1, and obtains subset font data including the extracted glyphs (glyph data). In addition to the glyph data, the subset font data may include information indicating the character order and character codes. The font server 8 transmits this subset font data to the backend app 12.

As an alternative, the backend app 12 may obtain the entire font data FD1 from the font server 8 in B24 and extract subset font data including one or more glyphs for each character in the character string “Condensed Milk” from the obtained font data. However, by obtaining from the font server 8 subset font data including only the glyphs corresponding to the characters constituting the inputted character string, the delivery server 1 can the communication data size compared with a configuration in which the delivery server 1 receives the entire font data FD1.

In B31 the backend app 12 generates image data of the specified character string based on the subset font data and the information used for generating the image data specified in the request of B23. The image data generated in B31 is used for displaying an image of the specified character string rendered in the server font identified by the identification information specified in the character data transmission request. The image data generated in B31 represents the image of the specified character string rendered in the server font identified by the identification information specified in the character data transmission request. In other words, the image data generated in B31 represents an image of the character string inputted on the source PC 2 and rendered in the server font selected from the server font list on the source PC 2. The image data generated in B31 is an example of specific data and is also an example of first image data. The image represented by the image data generated in B31 is an example of a character string image and is also an example of a first character string image.

For example, the backend app 12 renders the outline of each character in the character string “Condensed Milk” according to the glyphs in the subset font data. The backend app 12 also enlarges or reduces each character according to the font size included in the information used for generating the image data. The backend app 12 colors the interior of the outline of each character according to the text color included in the information used for generating the image data. The backend app 12 also colors the background for each character according to the background color included in the information used for generating the image data. The backend app 12 rasterizes the data rendered according to the glyphs, text color, background color, and font size to generate image data.

In B32 the backend app 12 passes the image data generated in B31 to the frontend app 11. In B33 the frontend app 11 transmits the image data received from the backend app 12 to the source PC 2, which is the source of the character data transmission request in B22.

Through the label editing app 22, in B34 the source PC 2 places the image data received from the frontend app 11 in the selected text object OB11 and displays on the user interface 21 the text object OB11 in which the received image data is placed. Thus, the user can create or edit the label data while checking the label data displayed by the delivery server 1.

The backend app 12 may also receive a character data transmission request in B23 specifying only a font name and character string, generate image data of the specified character string (B24, B31), and transmits this image data to the source PC 2. In response to receiving this image data, the label editing app 22 installed on the source PC 2 may process the image data in accordance with the text color of the sheet, the background color of the sheet, the font size, and the like set in the label editing screen D1, and may place the processed image data in the text object OB11.

The delivery server 1 may also obtain a server font list, obtain subset font data, and generate image data each time one character is inputted into the selected text object. However, the delivery server 1 can reduce the frequency of communications with the font server 8 by obtaining a server font list, obtaining subset font data, and generating image data each time a character string is inputted.

### Uploading Label Data

Next, a procedure for uploading label data generated on the source PC 2 to the delivery server 1 will be described.

When the user operates an Upload button SW13 displayed in the label editing screen D1 of FIG. 3, in C01 the label editing app 22 transmits an upload request to the frontend app 11. The upload request is accompanied by label data corresponding to the image IM11 displayed in the label editing screen D1. Here, in label data generated using the label editing app 22 and containing one or more text objects, a character string is set as a component of a label defined by the label data, and identification information (e.g., a font name) identifying a server font from among the server fonts included in the server font list is set as a font attribute. More specifically, in label data generated using the label editing app 22 and containing one or more text objects, a character string and a server font included in the server font list (specifically, identification information identifying the server font from among the server font list) are set for each text object. For example, in the label data attached to the upload request transmitted in C01, the character string “Condense Milk” is set as a component of a label defined by the label data, and the identification information (i.e., the font name “Font Name NA”) identifying the server font selected from the server font list is set as a font attribute.

In C02 the frontend app 11 forwards the upload request and the label data to the backend app 12. In C03 the backend app 12 stores the label data attached to the upload request in the label database 13. That is, in response to label data being uploaded to the delivery server 1 from the source PC 2, the delivery server 1 stores the uploaded label data in the label database 13. In C04 and C05, the backend app 12 transmits a storage result, which indicates whether the label data has been successfully stored, to the label editing app 22 via the frontend app 11. The label editing app 22 then displays the storage result. The label database 13 is an example of a storage.

The label data generated using the label editing app 22 specifies server fonts when the label data contains text objects. In other words, the label data to be uploaded does not specify fonts represented by font data that is possessed by the source PC 2 but is not available to the delivery server 1, such as the font data FD11. Therefore, label data in which server fonts have been specified can be uploaded to the delivery server 1 and stored in the label database 13.

The label editing app 22 may also store label data edited in the label editing screen D1 in response to an operation on a Save button SW12. For example, the delivery server 1 may provide an upload screen to the source PC 2, receive a specification of label data to be uploaded and an upload instruction in the upload screen, and store the label data generated using the label editing app 22 in the label database 13.

### Displaying Label Data

Next, a procedure in which the delivery server 1 displays, on the destination PC 3, label data stored in the label database 13 will be described. The following description will cover a case in which the delivery server 1 displays label data uploaded from the source PC 2 on the destination PC 3 in response to a display request from the destination PC 3.

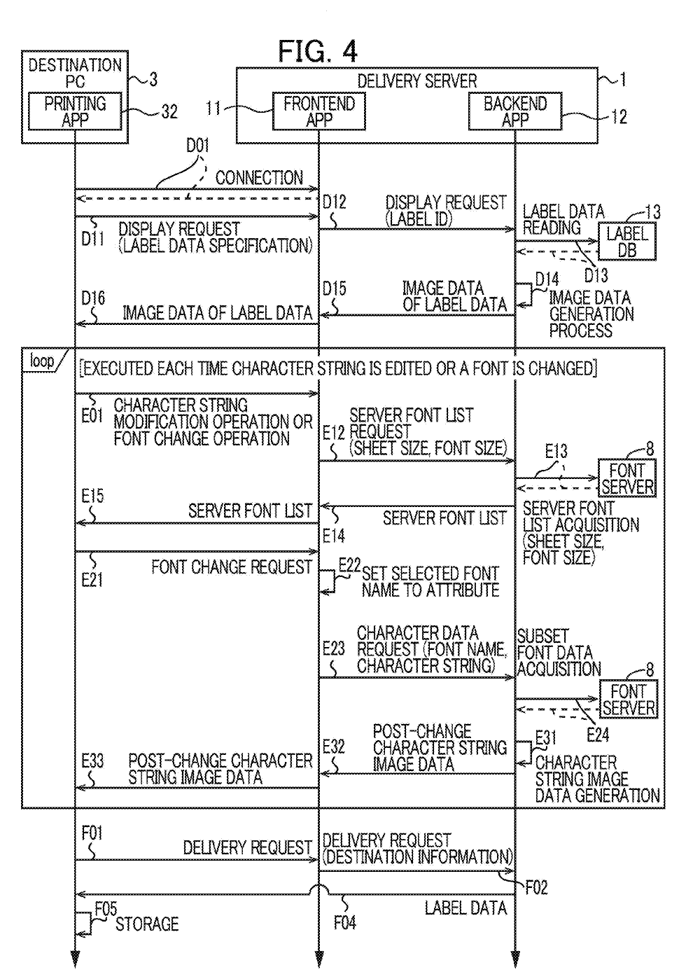

As shown in FIG. 4, in D01 the destination PC 3 connects to the frontend app 11 using a browser installed on the destination PC 3 or a browser function of the printing app 32. Once the user of the destination PC 3 has selected label data to be displayed from among the label data stored in the label database 13, in D11 the destination PC 3 transmits a display request to the delivery server 1. The display request is a request to display the selected label data on the destination PC 3. That is, the display request specifies a set of label data selected from among the plurality of sets of label data stored in the delivery server 1.

For example, when the frontend app 11 receives from the destination PC 3 a request to display a label list on the destination PC 3, the frontend app 11 obtains the label list from the label database 13 via the backend app 12 and displays the label list on the destination PC 3. Specifically, the frontend app 11 obtains the label name and a sample image for each set of label data recorded in the label database 13 and displays on the destination PC 3 a label list including the label names and sample images. In the label list, each of the sample images is associated with a corresponding one of the label names. In response to receiving an operation to select one set of label data from the displayed label list, and an operation to request to display the selected set of label data, in D12 the frontend app 11 forwards the display request for the selected set of label data to the backend app 12. This display request specifies the selected set of label data. Specifically, this display request specifies the label ID of the selected set of label data.

In D13 the backend app 12 reads, from the label database 13, the label data corresponding to the label ID specified in the display request. In D14 the backend app 12 executes an image data generation process based on the label data read from the label database 13. The image data generation process is a process to generate image data of the label data.

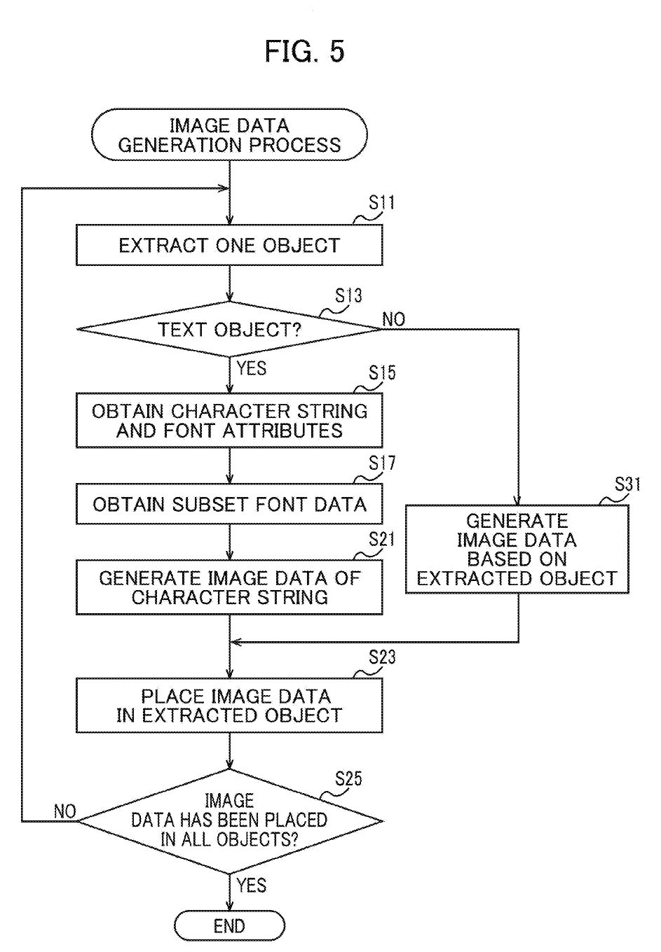

The image data generation process will be described next with reference to FIG. 5. In S11 the backend app 12 extracts one object from the label data read in D13. In S13 the backend app 12 determines whether the extracted object is a text object.

When the extracted object is a text object (S13: YES), in S15 the backend app 12 obtains the character string and font attributes specified for the extracted text object. Examples of font attributes are the type, font name, and font size of the font set in the label data. The backend app 12 may also obtain, as font attributes, the text color and background color of the sheet set in the label data. In S17 the backend app 12 obtains, from the font server 8, subset font data including one or more glyphs for each character in the character string obtained in S15. Since the method of obtaining subset font data is identical to that in B24 of FIG. 2, a description of this method will not be repeated here. In S21 the backend app 12 generates image data of the character string based on the obtained subset font data. The image data generated in S21 represents an image of the character string set for the text object extracted in S11 and rendered in the server font set for the extracted text object. The subset font data obtained in S17 is an example of second subset font data. The image data generated in S21 is an example of second image data. The image represented by the image data generated in S21 is an example of a second character string image.

For example, when the backend app 12 obtains the character string “Condensed Milk” and the font attributes of the server font represented by the font data FD1 from the specified label data, the backend app 12 then obtains, from the font server 8, subset font data extracted from the font data FD1 and including one or more glyphs for each character in the character string “Condensed Milk.” The backend app 12 renders the outline of each character according to the obtained subset font data. The backend app 12 also enlarges or reduces each character according to the font size included in the font attributes obtained in S15. The backend app 12 also colors the interior of the outline for each character according to the text color of the sheet included in the font attributes and colors the background of each character according to the background color of the sheet included in the font attributes. The backend app 12 rasterizes the rendered data of the character string to generate image data of the character string.

In S23 the backend app 12 places the generated image data of the character string in the text object OB11 extracted in S11. In S25 the backend app 12 determines whether image data has been placed in all objects contained in the label data. For example, when image data has not been placed in at least one of the text objects OB12, OB13, and OB14, the backend app 12 determines that not all objects in the label data have image data placed thereon in (S25: NO) and returns to S11. In S11 the backend app 12 extracts the next object and repeats the above process from S13.

When the extracted object is not a text object (S13: NO), in S31 the backend app 12 generates image data based on the extracted object. In S23 the backend app 12 places the image data generated in S31 in the extracted object and advances to S25.

Once the backend app 12 has placed image data in all objects contained in the label data (S25: YES), the backend app 12 ends the image data generation process, thereby completing generation of image data of the label data read in D13.

After the backend app 12 has completed the image data generation process in D14 of FIG. 4, in D15 the backend app 12 passes the generated image data of the label data to the frontend app 11. Image data of label data is formed by placing image data in each object included in the label data. In D16 the frontend app 11 transmits the image data of the label data received from the backend app 12 to the destination PC 3 that is the source of the display request in D11. In other words, in D16 the frontend app 11 transmits the image data generated in D14 of FIG. 4 (S21 of FIG. 5) to the destination PC 3. The destination PC 3 displays the image data of the label data received from the frontend app 11 on the user interface 31.

In the label data uploaded from the source PC 2 to the delivery server 1, server fonts, which are available to the delivery server 1, are specified for the character strings. Accordingly, the destination PC 3 displays character strings in the fonts intended by the person who uploaded the label data.

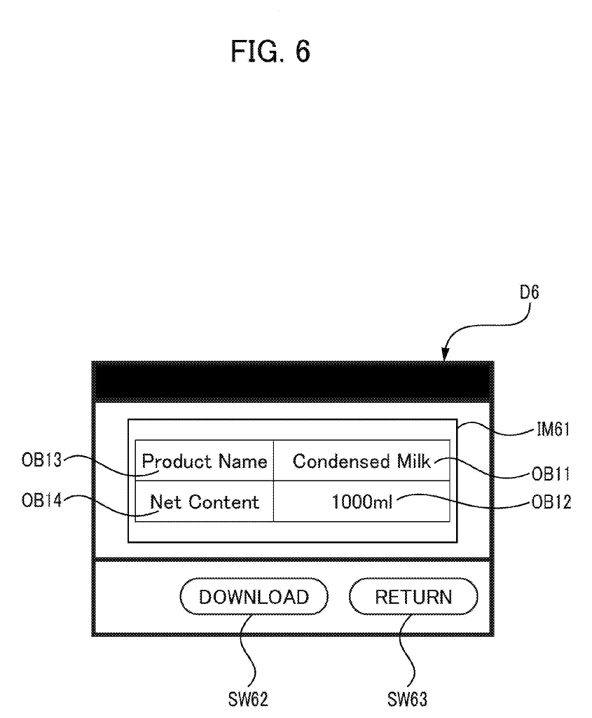

FIG. 6 shows an example of a label display screen D6 for displaying an image IM61 based on image data of label data. The label display screen D6 is provided to the destination PC 3 by the delivery server 1. The image IM61 based on image data of label data received from the delivery server 1 is displayed on the label display screen D6. In other words, a preview image of a label defined by label data specified in the display request is displayed on the label display screen D6. The label display screen D6 includes a Download button SW62, and a Return button SW63.

When the Download button SW62 is operated, in F01 of FIG. 4 the destination PC 3 transmits a delivery request to the frontend app 11, and the frontend app 11 receives the delivery request. In F02 the frontend app 11 requests the backend app 12 to transmit the label data. The request includes destination information for the destination PC 3 that is the source of the display request.

In F04 the backend app 12 transmits the label data specified in the display request of D11, i.e., the label data read from the label database 13 in D13, to the destination PC 3 in accordance with the destination information received in F02. The backend app 12 may also deliver the label data to the destination PC 3 via the frontend app 11. In F04 the destination PC 3 receives the delivered label data and in F05 stores the label data. When the Return button SW63 is operated in the label display screen D6, the frontend app 11 returns the display to the previously displayed screen. Note that the delivery request received from the destination PC 3 in F01 may specify a set of label data (i.e., label data to be delivered to the destination PC 3) from among the plurality of sets of label data stored in the delivery server 1, and the backend app 12 may transmit the set of label data specified in the delivery request to the destination PC 3. The delivery request received in F01 is an example of a second delivery request.

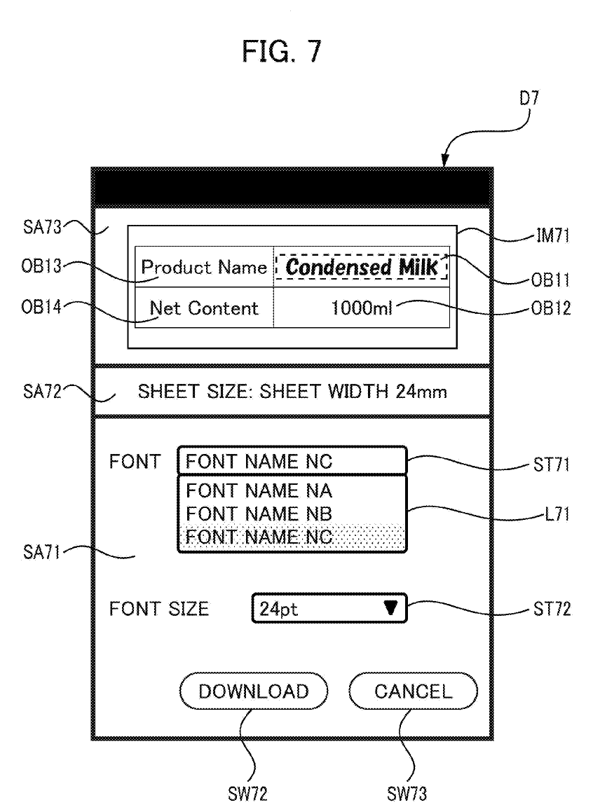

On the other hand, when the text object OB11 is selected in the label display screen D6 from among the text objects OB11, OB12, OB13, and OB14 included in the image IM61, the frontend app 11 provides a web editing screen D7 shown in FIG. 7 to the destination PC 3 and can receive modifications to character strings constituting the label data and modifications to fonts specified for the character strings. The web editing screen D7 shown in FIG. 7 shows the character string of the text object OB11 displayed in a post-change font.

Note that the label display screen D6 displaying a preview image of the label data and the web editing screen D7 that receives editing operations for the label data may be displayed as a single screen. Further, the delivery server 1 may be configured to display the web editing screen D7 only when the person who created the label data corresponding to the displayed preview image has permitted editing of the label data.

The web editing screen D7 includes an image editing display area SA73, a basic information display area SA72, an object attribute setting area SA71, a Download button SW72, and a Return button SW73. An image IM71 of the label data to be edited is displayed in the image editing display area SA73.

The preview image of the label data displayed in the label display screen D6 is initially displayed in the image editing display area SA73. The user can select one object to be edited from among the objects placed in the image displayed in the image editing display area SA73. When a text object has been selected, the web editing screen D7 can receive modifications to the character string in the selected text object.

The basic information display area SA72 displays the sheet size set for the label data displayed in the image editing display area SA73. The basic information display area SA72 may further display the last update date, the data size, and the like.

Setting items for object attributes are displayed in the object attribute setting area SA71. When the text object OB11 has been selected, for example, the object attribute setting area SA71 displays a font selection field ST71 for selecting a font, and a font size setting field ST72 for setting a font size. The font and font size set in the label data displayed in the image editing display area SA73 are displayed as initial values in the font selection field ST71 and font size setting field ST72, respectively. The user can change the font and font size of the label data through the font selection field ST71 and font size setting field ST72.

After one text object is selected from among the text objects displayed in the web editing screen D7, the delivery server 1 performs the process in E01-E33 of FIG. 4 each time the character string for the selected text object is edited, or each time the font for the selected text object is changed.

Specifically, for example, when the frontend app 11 receives an operation to modify the character string in the text object OB11 or an operation to change the font set in the font selection field ST71 in E01, in E12 the frontend app 11 requests the backend app 12 to transmit a server font list. This request specifies the sheet size set in the label data displayed in the image editing display area SA73 and the font size set in the font size setting field ST72.

In E13 the backend app 12 obtains a server font list including server fonts suitable for the specified sheet size and font size from the font server 8 and in E14 passes this list to the frontend app 11. In E15 the frontend app 11 provides a screen including the server font list received from the backend app 12 to the destination PC 3. For example, as shown in FIG. 7, the identification information (e.g., the font names in this example) identifying the server fonts included in the server font list is displayed in a font list L71 displayed in the font selection field ST71. The server font list obtained in E13 is an example of a second server font list. The server fonts included in the server font list obtained in E13 are an example of second server fonts. The font list L71 is an example of the second server font list.

When one set of identification information (a font name) identifying a server font is selected from the font list L71, in E21 the frontend app 11 receives a font change request. The font change request specifies the server font selected from the font list L71. Based on this font change request, in E22 the frontend app 11 sets an attribute of the text object OB11 to the font name of the selected server font. This selected server font is an example of another server font. For example, when the font for the text object OB11 is changed from the server font represented by the font data FD1 to the server font represented by the font data FD21, the frontend app 11 sets the font name “Font Name NC,” which is the font name of the server font represented by the font data FD21, for the text object OB11.

After the font has been changed, in E23 the frontend app 11 requests the backend app 12 to transmit character data. In this example, this character data transmission request specifies the font name “Font Name NC” set for the text object OB11 in E22, and the character string “Condensed Milk” that has been inputted into the text object OB11. The character data transmission request may also specify the font size set in the font size setting field ST72.

In response to receiving the character data transmission request in E23, in E24 the backend app 12 obtains, from the font server 8, subset font data that includes glyphs for each character in the specified character string “Condensed Milk.” Since the process of E24 is identical to that of B24 in FIG. 2, a description of the process will not be repeated here. In other words, for the character string “Condensed Milk,” the backend app 12 obtains, from the font server 8, subset font data based on the post-change server font (i.e., the server font selected from the font list L71). The subset font data obtained in E24 is an example of fourth subset font data.

In E31 the backend app 12 generates image data of the specified character string “Condensed Milk” based on the subset font data obtained from the font server 8. That is, the image data generated in E31 represents an image of the character string “Condensed Milk” rendered in the server font specified in the font change request. For example, the backend app 12 renders the outline of each character in the character string “Condensed Milk” according to glyphs in the subset font data extracted from the font data FD21 corresponding to the font name “Font Name NC” of the server font specified in the font change request. The backend app 12 also enlarges and reduces each character according to the font size set in the font size setting field ST72. The backend app 12 also colors the interior of the outline of each character and the background of each character according to the text color and background color of the sheet specified in the label data being edited. In E31 the backend app 12 rasterizes the rendered data for the character string to generate image data. In E32 the backend app 12 passes the generated image data of the character string to the frontend app 11. The image data generated in E31 is an example of fourth image data. The image represented by the image data generated in E31 is an example of a fourth character string image.

In E33 the frontend app 11 replaces the image data of the character string placed in the text object OB11 displayed in the web editing screen D7 with the image data of the character string received from the backend app 12 in E32. In other words, in E33 the frontend app 11 transmits, to the destination PC 3, data for displaying the web editing screen D7 in which the image data generated in E31 is placed in the text object OB11. That is, in E33 the frontend app 11 transmits the image data generated in E31 to the destination PC 3. As a result, in E33 the character string “Condensed Milk” is displayed in the post-change font on the destination PC 3. Hence, the delivery server 1 can display, on the destination PC 3, image data of label data reflecting the change in font.

When the character string in the text object OB11 is edited by adding, deleting, or changing one or more characters in E01, for example, the delivery server 1 can execute the same process described in E12-E33 to generate image data of the modified character string based on the specified server font, and display this image data on the user interface 31 of the destination PC 3. Specifically, for example, when an operation to modify the character string in the text object OB11 is performed on the web editing screen D7, in E01 the delivery server 1 receives a request to modify the character string in the text object OB11. This request specifies a modified character string. In response to receiving the request in E01, in E24 the delivery server 1 obtains, from the font server 8, subset font data based on the font data for the server font identified by the identification information set in the selected set of label data specified in the display request received in D11. The subset font data includes glyphs of the characters included in the modified character string specified in the request received in E01. In E31 the delivery server 1 generates image data of the modified character string based on the obtained subset font data. The image data generated in E31 represents an image of the modified character string rendered in the identified server font. In E33 the frontend app 11 transmits, to the destination PC 3, data for displaying the web editing screen D7 in which the image data generated in E31 is placed in the text object OB11. In other words, in E33 the delivery server 1 transmits the image data generated in E31 to the destination PC 3. Note that the request received in E01 may further specify the selected set of label data specified in the display request received in D11. The request received in E01 is an example of a character string modification request. The subset font data obtained in E24 is an example of third subset font data. The image data generated in E31 is an example of third image data. The image represented by the image data generated in E31 is an example of a third character string image.

The delivery server 1 may also execute the process in E12-E33 each time one character of a character string is modified.

When the Download button SW72 displayed in the web editing screen D7 of FIG. 7 is operated, in F01 of FIG. 4 the frontend app 11 receives a delivery request and in F02 requests the backend app 12 to deliver label data. In this case, the frontend app 11 passes information on the character string and server font modified in the web editing screen D7 to the backend app 12 in addition to destination information for the destination PC 3. Note that, when a delivery request is received, the frontend app 11 may also provide, to the destination PC 3, a screen to confirm whether the download target is the pre-edited label data or the edited label data.

The backend app 12 duplicates the label data specified in the display request received in D11, changes the character string and font of the duplicated label data to the character string and server font modified in the web editing screen D7, and in F04 transmits the modified label data to the destination PC 3 in accordance with the destination information. In F05 the destination PC 3 receives and stores the modified label data.

In this way, the delivery server 1 can deliver label data reflecting changes to the character string and font received via the web editing screen D7 to the destination PC 3, which is the source of the display request, while preserving the uploaded label data in the original state. Therefore, the person who issued the display request can download label data reflecting the character strings and fonts edited by the person to the destination PC 3, thereby improving convenience.

When the Return button SW73 displayed in the web editing screen D7 of FIG. 7 is operated, the frontend app 11 returns the display to the previously displayed label display screen D6.

### Delivering Label Data to the Label Printer 5

Next, operations for delivering label data from the delivery server 1 to the label printer 5 directly will be described.

In response to an operation on the operation panel 5a, for example, the label printer 5 displays label data stored on the delivery server 1 on the operation panel 5a and receives a selection of one set of label data to be downloaded from among the displayed label data. In response to receiving, via the operation panel 5a, an instruction to issue a delivery request, the label printer 5 transmits a delivery request to the delivery server 1 specifying the selected label data. This delivery request may also specify the destination information for the label printer 5, i.e., may specify the label printer 5 as the delivery destination for the selected label data. The delivery request received from the label printer 5 is an example of a first delivery request.

In response to receiving the delivery request from the label printer 5, the frontend app 11 forwards the delivery request to the backend app 12. At this time, the frontend app 11 adds the destination information for the label printer 5, which is the source of the delivery request, to the delivery request to be forwarded. The backend app 12 reads the label data specified in the delivery request from the label database 13 and transmits the read label data to the label printer 5 according to the destination information added to the delivery request. The backend app 12 may transmit the label data to the label printer 5 via the frontend app 11. The label printer 5 then receives and stores the delivered label data.

The label printer 5 may receive settings specifying the label data to be delivered and the timing for transmitting a delivery request in advance and may automatically transmit the delivery request specifying the label data to the delivery server 1. The timing for transmitting the delivery request may be a predetermined timing, such as when the printing app 32 is started up, or may be a periodic timing, such as once a week. The delivery request automatically transmitted from the label printer 5 is also an example of a first delivery request.

Further, when uploaded label data is associated with a label printer (e.g., the label printer 5) set as the delivery destination, the delivery server 1 may deliver the label data to the label printer (e.g., the label printer 5) by push delivery at a timing set on the delivery server 1.

### Printing Label Data

When a print instruction to print label data delivered to the destination PC 3 from the delivery server 1 is issued, for example, the printing app 32 generates a print command instructing printing based on the delivered label data (the downloaded label data in this embodiment) and transmits this print command to the label printer 5. The label printer 5 prints the label data according to the print command.

The label printer 5 stores the label data delivered by the delivery server 1, for example, and perform printing based on the delivered label data in response to receiving a specification of the delivered label data and a device-side print instruction via the operation panel 5a.

As described above, the delivery server 1 according to the first embodiment provides a list of server fonts, which are available to the delivery server 1, to the source PC 2 from which label data is to be uploaded. When the creator of the label data subsequently selects one of the server fonts as a text font and inputs a character string on the source PC 2, the delivery server 1 obtains subset font data for the character string inputted on the source PC 2 based on font data for the server font selected on the source PC 2 and uses this subset font data to display an image of the inputted character string on the source PC 2. As a result, the character string is displayed on the source PC 2 in the font intended by the creator of the label data.

Further, the delivery server 1 even generates image data of character strings and the label editing app 22 simply displays this image data received from the delivery server 1. Therefore, the source PC 2 need not generate the image data, thereby reducing the processing load on the source PC 2.

Fonts that include kanji contain a large number of characters with complex character shapes, for example. Therefore, the data size of the font data storing this font information is large. Hence, in a case where the label editing app 22 and the delivery server 1 work together to edit character strings while changing fonts, if the label editing app 22 were to download font data from the delivery server 1 (i.e., if the delivery server 1 were to transmit font data to the label editing app 22), the amount of communication between the label editing app 22 and the delivery server 1 would increase, which would cause the occurrence of wait times for downloading the font data. However, since the delivery server 1 of the first embodiment transmits image data of character strings rather than font data, the amount of communication between the label editing app 22 and the delivery server 1 are less than if the delivery server 1 were to transmit font data. Hence, there is unlikely to be wait times during text editing.

### Second Embodiment

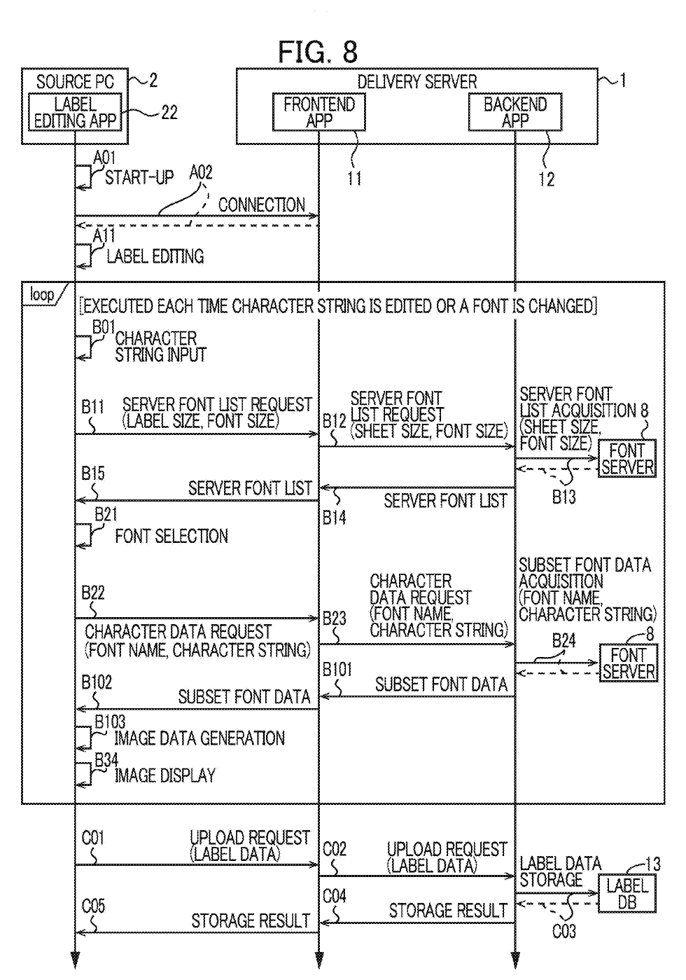

Next, a delivery server and label editing app according to a second embodiment will be described. In the second embodiment shown in FIG. 8, the backend app 12 transmits subset font data obtained from the font server 8 to the label editing app 22, and then, the label editing app 22 generates image data based on the subset font data. This point differs from the first embodiment in which the backend app 12 generates image data based on the subset font data and transmits the image data to the label editing app 22. The description of the second embodiment will focus on the differences from the first embodiment. For common points, the same reference numerals and step numbers from the first embodiment will be used, and descriptions of these steps and components will be omitted as appropriate.

When the frontend app 11 receives a character data request in B22, in B23 the frontend app 11 forwards the character data request to the backend app 12. In B24 the backend app 12 obtains, from the font server 8, subset font data suitable for at least one of the sheet size and font size specified in the character data request. In B101 the backend app 12 passes this subset font data to the frontend app 11. In B102 the frontend app 11 transmits the subset font data received from the backend app 12 to the source PC 2. The subset font data transmitted in B102 is used for displaying an image of the inputted character string rendered in the server font selected from the server font list. The subset font data transmitted in B102 is an example of specific data.

In response to receiving the subset font data transmitted from the frontend app 11 in B102, in B103 the label editing app 22 generates image data of the inputted character string based on the subset font data. For example, the label editing app 22 renders the outlines of the characters in the inputted character string according to glyphs included in the subset font data. The label editing app 22 also colors the interior of the outline of each character and the background according to the text color and background color of the sheet set in the label editing screen D1. The label editing app 22 further enlarges or reduces each character according to the font size set in the label editing screen D1. The label editing app 22 rasterizes the rendered data for the character string to generate image data. The image data generated in B103 represents an image of the inputted character string rendered in the server font selected from the server font list. The image data generated in B103 is an example of first image data. The image represented by the image data generated in B103 is an example of a first character string image.

In B34 the label editing app 22 places the generated image data of the character string in the selected text object OB11 and displays the generated image data of the character string in the label editing screen D1.

Since the delivery server 1 according to the second embodiment does not generate image data but transmits the subset font data to the source PC 2, the amount of transmitted data is less than that in the first embodiment in which image data is transmitted to the source PC 2. Accordingly, the second embodiment reduces the communication load for displaying images of character strings on the source PC 2.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the layout and contents of each screen are not limited to those of the above embodiments. For example, the delivery server 1 need not be communicatively connected to the font server 8 but may store, in the internal memory (e.g., the storage 18) of the delivery server 1, font data for fonts available to the delivery server 1.

In response to a display request from the destination PC 3, for example, the delivery server 1 need not obtain subset font data from the font server 8 to generate image data and transmit this image data to the destination PC 3. However, when the source PC 2 uploads label data to the delivery server 1 and then the delivery server 1 receives a display request to display that label data from the destination PC 3, the delivery server 1 obtains subset font data for displaying a character string set in the label data to be displayed based on font data for a server font set in the label data to be displayed and uses this subset font data to display an image of the character string set in the label data on the destination PC 3, thereby displaying the character string on the destination PC 3 in the font intended by the creator of the label data.

Steps E01-E33 of FIG. 4 may be omitted, for example. However, the delivery server 1 can improve user convenience by receiving, in response to a display request from the destination PC 3, modifications to character strings or changes to fonts in the label data to be displayed, obtaining subset font data according to the modifications or the changes, and modifying the display image. Further, by allowing the user to change fonts among the server fonts available to the delivery server 1, the delivery server 1 can display a character string on the destination PC 3 in a font selected by the modifier.

In the above embodiments, the delivery server 1 does not save label data edited in the web editing screen D7 in the label database 13. However, the delivery server 1 may save label data edited in the web editing screen D7 in the label database 13 as new label data. Alternatively, the delivery server 1 may overwrite existing label data with the label data edited in the web editing screen D7. In a configuration where edited label data is saved as new label data or written over existing label data, the delivery server 1 may receive an instruction in the web editing screen D7 to save the edited label data or overwrite the existing label data, may receive a delivery request (a download instruction) via a separate screen from the web editing screen D7, and may transmit the edited label data to the source of the delivery request.

In the above embodiments, the destination PC 3 downloads saved label data in response to an operation on the Download button SW62 in FIG. 6. However, the printing app 32 may receive specifications of label data to be downloaded and settings for timings to transmit delivery requests in advance and may automatically transmit the delivery requests to the delivery server 1. The timing for transmitting a delivery request may be a predetermined timing, such as when the printing app 32 is started up, or a periodic timing, such as once a week. The delivery request automatically transmitted from the printing app 32 is an example of a second delivery request.

For example, when the destination PC 3 is associated with uploaded label data as the delivery destination, the delivery server 1 may transmit the label data to the specified destination PC 3 by push delivery at a timing set on the delivery server 1.

Processes executed by the destination PC 3 in FIG. 4 may be executed by the source PC 2 instead. In other words, the source PC 2 may also be an example of a second device.

In any of the sequence diagrams disclosed in the embodiments, the processes may be executed in any order or in parallel as long as the processing does not become inconsistent. There is no restriction on which comes first between a character string input or modification and a font selection or change. Further, the order of executing the process for rendering an outline of each character based on glyphs, the process for coloring the inside of the outlines, the process for coloring the background, and the process for enlarging or reducing each character may differ from that in the above embodiments.

The processes disclosed in the above embodiments may be executed by a single CPU, a plurality of CPUs, an ASIC or other hardware, or a combination of these components. Furthermore, the processes disclosed in the embodiments may be may be implemented in various forms, such as a storage medium storing a program for executing the processes, or as a method.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

The term “processor” encompasses both a single processor or a group of multiple processors located either locally or remotely working together or in a distributed fashion to collectively perform the tasks attributed to the “processor” described herein.

What is claimed is:

1. A delivery server configured to be connected to a network, comprising:
a controller configured to perform:
in response to receiving a font list request transmitted from a first device configured to be connected to the network,
transmitting a first server font list to the first device, the first server font list being a list of server fonts, the server fonts being fonts available to the delivery server; and
in response to receiving a specific data request transmitted from the first device that is in receipt of the first server font list, the specific data request specifying a character string inputted on the first device, the specific data request further specifying identification information identifying a server font selected from the first server font list on the first device,
obtaining specific data used for displaying a first character string image, the first character string image being an image of the specified character string rendered in the server font identified by the identification information specified in the received specific data request; and
transmitting the obtained specific data to the first device.

2. The delivery server according to claim 1,
wherein the specific data is first image data, the first image data being image data representing the first character string image, and
wherein the obtaining including:
obtaining first subset font data based on font data for the identified server font, the first subset font data being subset font data including glyphs of characters included in the specified character string; and
generating the first image data based on the obtained first subset font data.

3. The delivery server according to claim 2,
wherein the delivery server is configured to communicate with a font server possessing font data for each of the server fonts,
wherein, in the obtaining the first subset font data, the controller obtains the first subset font data from the font server, the first subset font data being data included in the font data for the server font identified by the identification information specified in the received specific data request, and
wherein, in the generating, the controller generates the first image data based on the first subset font data obtained from the font server.

4. The delivery server according to claim 1,
wherein the font list request specifies a sheet size, and
wherein the server fonts included in the first server font list are fonts suitable for the sheet size specified in the font list request from among fonts available to the delivery server.

5. The delivery server according to claim 1,
wherein the font list request specifies a font size, and
wherein the server fonts included in the first server font list are fonts suitable for the font size specified in the font list request from among fonts available to the delivery server.

6. The delivery server according to claim 2, further comprising:
a storage,
wherein the controller is configured to further perform:
in response to label data being uploaded to the delivery server from the first device that is in receipt of the first server font list,
storing the uploaded label data in the storage, and
wherein, in the label data that is uploaded to the delivery server from the first device, a character string is set as a component of a label defined by the label data, and identification information identifying a server font from among the server fonts included in the first server font list is set as a font attribute.

7. The delivery server according to claim 6,
wherein the controller is configured to further perform:
in response to receiving a first delivery request specifying the label data stored in the storage, the first delivery request further specifying a printer as a delivery destination for the label data,
transmitting the label data specified in the first delivery request to the printer specified in the first delivery request.

8. The delivery server according to claim 6,
wherein the storage stores a plurality of sets of label data uploaded to the delivery server, the plurality of sets of label data including the label data stored in the storing, and
wherein the controller is configured to further perform:
in response to receiving a first delivery request specifying a set of label data from among the plurality of sets of label data stored in the storage, the first delivery request further specifying a printer as a delivery destination for the set of label data,
transmitting the set of label data specified in the first delivery request to the printer specified in the first delivery request.

9. The delivery server according to claim 6,
wherein the controller is configured to further perform:
in response to receiving a second delivery request from a second device configured to be connected to the network, the second delivery request specifying the label data stored in the storage,
transmitting the label data specified in the second delivery request to the second device.

10. The delivery server according to claim 6,
wherein the storage stores a plurality of sets of label data uploaded to the delivery server, the plurality of sets of label data including the label data stored in the storing, and
wherein the controller is configured to further perform:
in response to receiving a second delivery request from a second device configured to be connected to the network, the second delivery request specifying a set of label data from among the plurality of sets of label data stored in the storage,
transmitting the set of label data specified in the second delivery request to the second device.

11. The delivery server according to claim 6,
wherein the storage stores a plurality of sets of label data uploaded to the delivery server, the plurality of sets of label data including the label data stored in the storing,
wherein, in each of the plurality of sets of label data stored in the storage, a character string and identification information identifying a server font from among the server fonts are set, and
wherein the controller is configured to further perform:
in response to receiving a display request from a second device configured to be connected to the network, the display request specifying a set of label data from among the plurality of sets of label data stored in the storage,
obtaining second subset font data based on font data for the server font identified by the identification information set in the set of label data specified in the display request, the second subset font data being subset font data including glyphs of characters included in the character string set in the specified set of label data;
generating second image data based on the obtained second subset font data, the second image data being image data representing a second character string image, the second character string image being an image of the character string set in the specified set of label data and rendered in the server font identified by the identification information set in the specified set of label data; and
transmitting the generated second image data to the second device.

12. The delivery server according to claim 11,
wherein the controller is configured to further perform:
in response to receiving a character string modification request from the second device after the second character string image represented by the second image data is displayed on the second device, the character string modification request being a request to modify the character string in the displayed second character string image, the character string modification request specifying a modified character string,
obtaining third subset font data based on the font data for the server font identified by the identification information set in the specified set of label data, the third subset font data being subset font data including glyphs of characters included in the modified character string specified in the character string modification request;
generating third image data based on the obtained third subset font data, the third image data being image data representing a third character string image, the third character string image being an image of the modified character string rendered in the server font identified by the identification information set in the specified set of label data; and
transmitting the generated third image data to the second device.

13. The delivery server according to claim 11,
wherein the controller is configured to further perform:
in response to receiving a font change request from the second device after the second character string image represented by the second image data is displayed on the second device, the font change request being a request to change a font of the character string in the displayed second character string image from the server font identified by the identification information set in the specified set of label data to another server font selected from a second server font list, the second server font list being a list of second server fonts, the second server fonts being fonts available to the delivery server,
obtaining fourth subset font data based on font data for the another server font, the fourth subset font data being subset font data including glyphs of characters included in the character string set in the specified set of label data;
generating fourth image data based on the obtained fourth subset font data, the fourth image data being image data representing a fourth character string image, the fourth character string image being an image of the character string set in the specified set of label data and rendered in the another server font; and
transmitting the generated fourth image data to the second device.

14. The delivery server according to claim 13,
wherein the font change request specifies a sheet size, and
wherein the server fonts included in the second server font list are fonts suitable for the sheet size specified in the font change request from among fonts available to the delivery server.

15. The delivery server according to claim 13,
wherein the font change request specifies a font size, and
wherein the server fonts included in the second server font list are fonts suitable for the font size specified in the font change request from among fonts available to the delivery server.

16. The delivery server according to claim 1,
wherein the specific data is subset font data including glyphs of characters included in the specified character string, and
wherein the obtaining including:
obtaining the subset font data based on font data for the identified server font.

17. A non-transitory computer-readable storage medium storing a set of computer-readable instructions for editing label data for a label, the set of computer-readable instructions, when executed by a processor of an information processing device configured to be connected to a network, causing the information processing device to perform:
obtaining a server font list from a delivery server configured to be connected to the network, the server font list being a list of server fonts, the server fonts being fonts available to the delivery server;
receiving a selection operation to select a server font from the obtained sever font list;
receiving an input operation to input a character string to be placed in a label;
transmitting a specific data request to the delivery server, the specific data request specifying identification information identifying the server font selected through the received selection operation, the specific data request further specifying the character string inputted through the received input operation;
receiving specific data that is transmitted from the delivery server in response to the specific data request, the specific data being data used for displaying a character string image, the character string image being an image of the inputted character string rendered in the selected server font; and
displaying, on a user interface of the information processing device, the character string image using the received specific data.

18. The non-transitory computer-readable storage medium according to claim 17,
wherein the specific data is image data representing the character string image, and
wherein the displaying displays, on the user interface, the character string image represented by the image data.

19. The non-transitory computer-readable storage medium according to claim 17,
wherein the specific data is subset font data based on font data for the selected server font identified by the identification information specified in the specific data request, the subset font data including glyphs of characters included in the inputted character string specified in the specific data request,
wherein the set of computer-readable instructions, when executed by the processor, causes the information processing device to further perform:
generating, based on the subset font data, image data representing the character string image, and
wherein the displaying displays, on the user interface, the character string image represented by the generated image data.
